(19) United States
(12) Patent Application Publication
(10) Pub. No.: US 2001/0035084 A1
(43) Pub. Date: Nov. 1, 2001

(54) Musical instrument tuner integral with a connector

(76) Inventor: Charles J. Kulas, San Francisco, CA (US)

Correspondence Address: Charles J. Kulas, 244 Texas St., San Francisco, CA, 94107, US

(21) Appl. No.: 09/840,689

(22) Filed: Apr. 23, 2001

Related U.S. Application Data
(60) Provisional application No. 60/204,038, filed on May 12, 2000.

(51) Int. Cl. G10D 3/00

(52) U.S. Cl. 84/290

(57) ABSTRACT

A tuner, such as for an electric guitar, is integrated with a connector or plug. The plug is a standard size that fits popular models of electric guitars. Thus, the tuner is mounted proximate to the instrument and is always within reach of the musician. The tuner does not require a separate cord to connect to the guitar. A preferred embodiment uses a compact display and lightweight battery. The tuner provides modes for inhibiting the sound of the instrument while tuning, or tuning while permitting sound from the instrument.

### CLAIM OF PRIORITY

This patent application claims priority from U.S. Provisional Patent Application Ser. No. 60/204,038; which is hereby incorporated by reference as if set forth in full in this document.

### BACKGROUND OF THE INVENTION

This invention relates in general to tuning devices for musical instruments and more specifically to a tuning device that is integral with a plug, or other connector, for mounting the tuning device proximately to an instrument.

Musical instrument tuners are useful for tuning instruments that go out of tune. Such instruments may go out of tune due to environmental conditions, wear or use of the instrument, by being incorrectly manipulated by a human, or for other reasons. An electric guitar is an example of an instrument that frequently needs to be tuned. Various types of electric guitars exist such as 6-string, 12-string, bass guitars, acoustic guitars with built-in electronic pickups, etc.

One popular type of guitar tuner is a small box that accepts a plug connected to a cord. The other end of the cord is also a plug that is inserted into the electric guitar. An additional cord goes from the tuner box to an amplifier or other signal destination such as recording equipment. The box typically has a switch to select a tuning mode. When in a tuning mode, the box includes indicators for showing whether the received tone is high, low, or “in tune.” Several manufacturers make this type of tuner, such as Korg, Roland, etc. See, for example, U.S. Pat. No. 5,396,827.

Although these types of tuners are popular, they have shortcomings.

One problem is that the tuner box is not always near the person tuning the guitar. For example, when a musician is playing a live show, the tuner is usually located near the guitar amplifier toward the back of the stage. Since the indicator on the tuner is small, the musician must go toward the back of the stage to tune the guitar. This is not conducive to a live show where the musician must turn his or her back to the audience.

Often the guitar tuner is not kept plugged in to the instrument. Musicians fail to keep a tuner plugged in because the tuner is a small device that can become pulled or dislodged from it's resting position as the musician moves around on the stage and pulls the cord connected between the guitar and the tuner. Also, there is often only 1 tuner that is shared among musicians on the stage. This means that the tuner is constantly being connected to, and disconnected from, different guitars or other instruments and never remains attached to one instrument.

Some manufacturers have tried to alleviate these problems by making a floor-located, footswitched, tuner that can remain up at the front of the stage. This approach suffers from the size of the indicator and the 5 or more feet between the musician's eyes and the tuner on the floor. This makes reading the indicator difficult. Also, a cable must be run from the guitar to the floor-located tuner and from the tuner to the amplifier. This creates more cables laying across the stage. Another problem is that guitar players typically use the immediate floorspace for other foot-operated devices like effects units, channel switchers, etc.

One tuner model provides a tuner that mounts to the surface of a guitar. This is described in U.S. Pat. No. 5,388,496. However, this tuner is only useful for acoustic guitars that have a hollow body that resonates. The tuner has a rubber adhesive side with an acoustic pickup head. The use of an acoustic pickup means that the tuner is sensitive to ambient noise, such as the crowd noise or sounds from other instruments. Such a tuner will not work with a non-acoustic instrument such as an electric guitar because an electric guitar's body does not resonate significantly. Another embodiment uses a tuner built into the body of the guitar with indicators mounted along the neck of the guitar. This approach is expensive and does not allow the tuner to be readily used with other instruments, as where a musician may have 2 or more guitars to be played at a show.

Another problem with traditional tuners is that they are often relatively expensive and, because of their size, easily misplaced or forgotten.

Thus, it is desirable to provide an improved musical instrument tuner.

### SUMMARY OF THE INVENTION

The present invention is a guitar tuner that is integrated with a connector or plug. The plug is a standard size that fits all popular electronic instruments, such as electric guitars. Since the tuner is integral with the standard plug, the tuner mounts immediately adjacent to the instrument when the integral plug is plugged into a jack on the instrument. Thus, the tuner is mounted proximately to the instrument and is always within convenient sight and reach of a musician playing the instrument.

Because of the integral design, the tuner does not require a separate cord to connect to the guitar. The tuner can be fitted with a separate jack for sending the signal from the tuner (or directly from the instrument) to an external device. A preferred embodiment uses a compact display and lightweight battery. The tuner provides modes for sending the instrument signal only to the tuner, bypassing the tuner and sending the signal directly to an external device, or for sending the signal to both the tuner and an external device.

Another embodiment provides for a tuner device that is integral with both a plug and a cable for coupling to an external device.

### BRIEF DESCRIPTION OF THE DRAWINGS

FIG. 1A shows a perspective view of the tuner of the present invention mounted to the body of an electric guitar;

FIG. 1B shows a side view of the tuner mounted to an instrument edge;

FIG. 1C shows a side view of the tuner mounted to an instrument face;

FIG. 2A shows a front view of a musician using the tuner of the present invention;

FIG. 2A shows a side view of a musician using the tuner of the present invention;

FIG. 3 illustrates the electronic operation of a selector switch; and

FIG. 4 shows a miniature alternative embodiment of the tuner of the present invention.

### DETAILED DESCRIPTION OF A PREFERRED EMBODIMENT

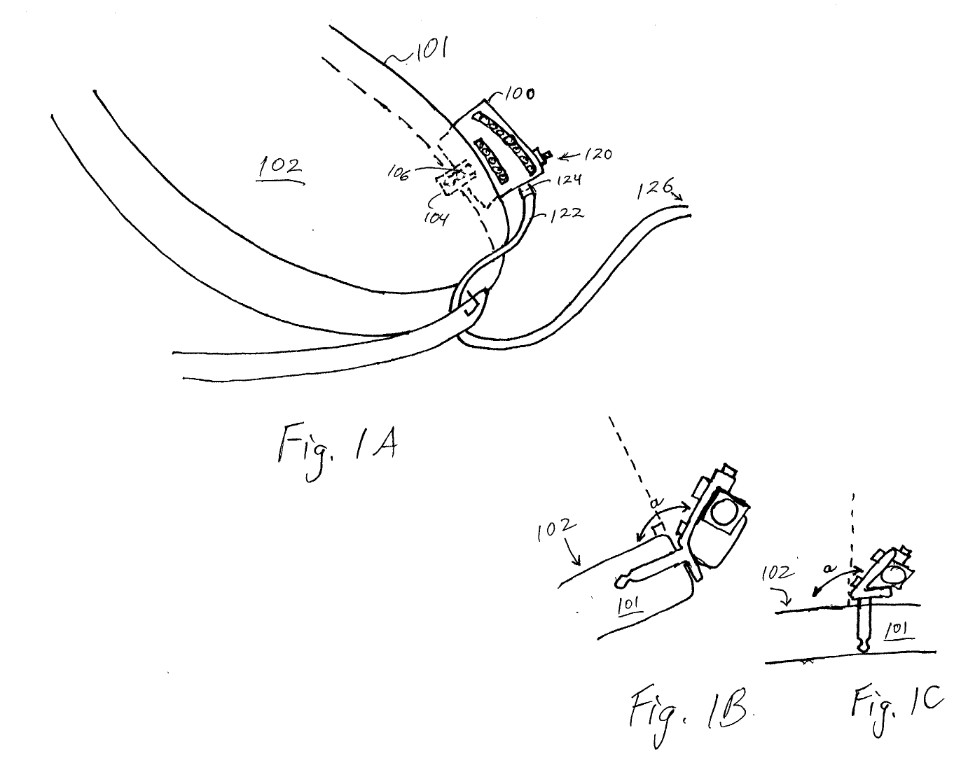

FIG. 1A shows a perspective view of the tuner of the present invention mounted to the body of an electric guitar.

In FIG. 1A, tuner 100 is mounted adjacent to guitar body 101 which has guitar top surface 102. The insertion of tuner plug 106 into guitar jack 104 provides sufficient mechanical coupling so that the tuner can not be removed from the guitar body without applying considerable force. Preferably, the tuner is made small and light enough that there is not undue force placed upon guitar jack 104 and so that the tuner will not slip out of the jack coupling.

Tuner 100 includes a selector switch 120 and two rows of indicator light-emitting diodes (LEDs). Cable 122 connects to the side of the tuner via tuner jack 124. Cable 122 is terminated in a plug (not shown) that is inserted into tuner jack 124. The other end of cable 122, at 126, is connected to another device such as an amplifier, recording equipment, etc. Tuner jack 124 is oriented so that when cable 122 is run behind guitar strap 125 the tuner is in a fixed rotation position about guitar jack 104 and is held in an optimal viewing position.

FIG. 1B shows a side view of the tuner mounted to the guitar edge. Note the display angle “a” which is relative to the plane of guitar top surface 102. Typically the display angle is greater than 90 degrees but less than about 135 degrees. A preferred embodiment of the invention has a display angle of about 110 degrees. However, any angle that results in a comfortable viewing position for a musician operating the an instrument being tuned by the invention is acceptable.

Some guitars, or other instruments, accept a plug inserted into the top surface of the instrument rather than at the edge. This top-mounted configuration is shown in FIG. 1C where the parts of the guitar such as body 101 and guitar top surface 102 are shown along with the display angle “a”. Note that the design of the tuner must change so that it is raked back more with respect to the plug so that a proper display angle is achieved. It should be apparent that any manner of instrument, display angle, tuner mounting, tuner indicators, etc., can be used, as appropriate. The edge-mounted configuration is used as an example throughout the rest of this specification.

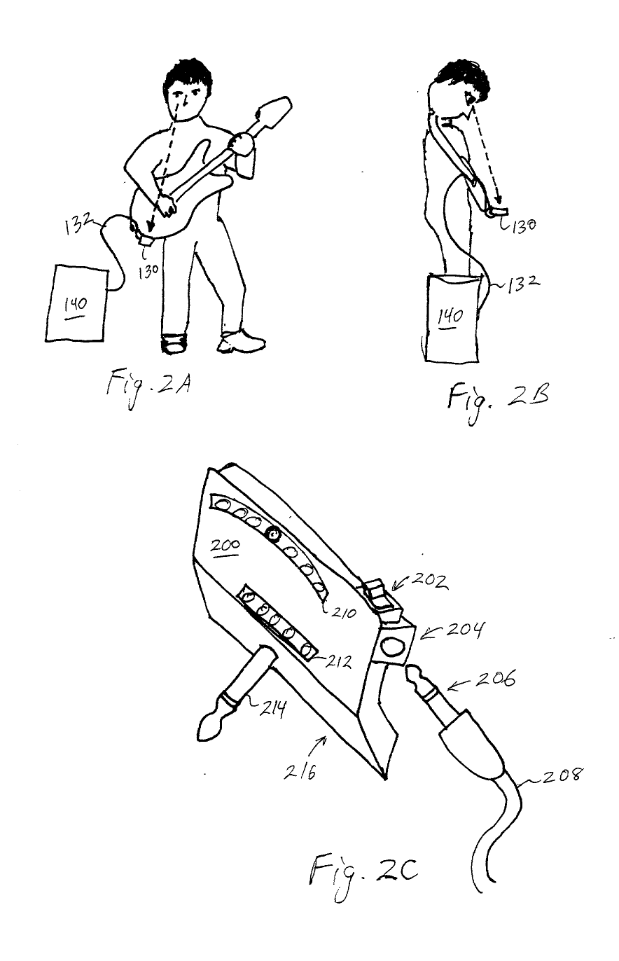

FIGS. 2A and 2B illustrate viewing positions of a musician using the tuner of the present invention.

In FIG. 2A, a front view of a musician holding a guitar is illustrated. Note that the tuner is easily viewable in its edge-mounted position adjacent to the guitar. Similarly, FIG. 2B shows the same configuration as in FIG. 2A, but from a side view. Both FIGS. 2A and 2B show tuner 130 plugged into an external device, such as amplifier 140, via cable 142. Note that the tuner is within easy view and reach of the musician. Also, there is only a single cord required between the musician/guitar/tuner combination and the amplifier.

FIG. 2C is a more detailed view of the tuner.

In FIG. 2C, tuner 200 includes selector switch 202, jack 204 for coupling to plug 206 and cable 208; fine tuning indicator 210, coarse tuning indicator 212 and plug 214 attached to sloped face 216 of the tuner. In the preferred embodiment, the plug and jack are standard ¼″ “phono” hardware.

Coarse and fine indicators function as is known in the art. A battery (not shown) is mounted to the back of the tuner. The operation of the selector switch is described in detail, below. A prototype of a preferred embodiment of the invention was made using electronics from a tuner made by Korg. These electronics use the coarse indicators to show the closest note, or string, being played. The fine indicators are then used to show when the specific string is in tune with the note indicated by the coarse indicator. Any manner of tuning schemes and indicators can be employed.

The tuner of the present invention can use any type of tuning electronics, indicators, jack and plug sizes, selector switch type and function, etc. The design of the tuner can deviate substantially from that shown in the Figs. It is envisioned that the tuner can be substantially reduced in size and weight to approximate that of a standard plug.

A smaller, future embodiment of the tuner is shown in FIG. 4.

FIG. 4 shows tuner 300 as an integral device with plug 302 and cable 304. The other end of cable 304 can be a standard plug for connecting to external devices. Indicators 306 are placed in a row at the top of the tuner/plug device. Note that only a single row of LED indicators are used. The single row can perform the fine tuning function of prior art tuners since s many musicians an approximate the sound of a string to within the coarse range without an indicator. Or, the single row of indicators can perform a dual function by using different colors, blinking or other approaches to indicate coarse and fine tunings. Such an approach is discussed, for example, in U.S. Pat. No. 5,396,827.

To further simplify and miniaturize the tuner of FIG. 4, a selector switch can be omitted so that the tuner is always on. Power can be supplied from a small battery, or from “phantom” power applied as a direct-current level to the sound is signals being conducted by the cable. Other arrangements are possible.

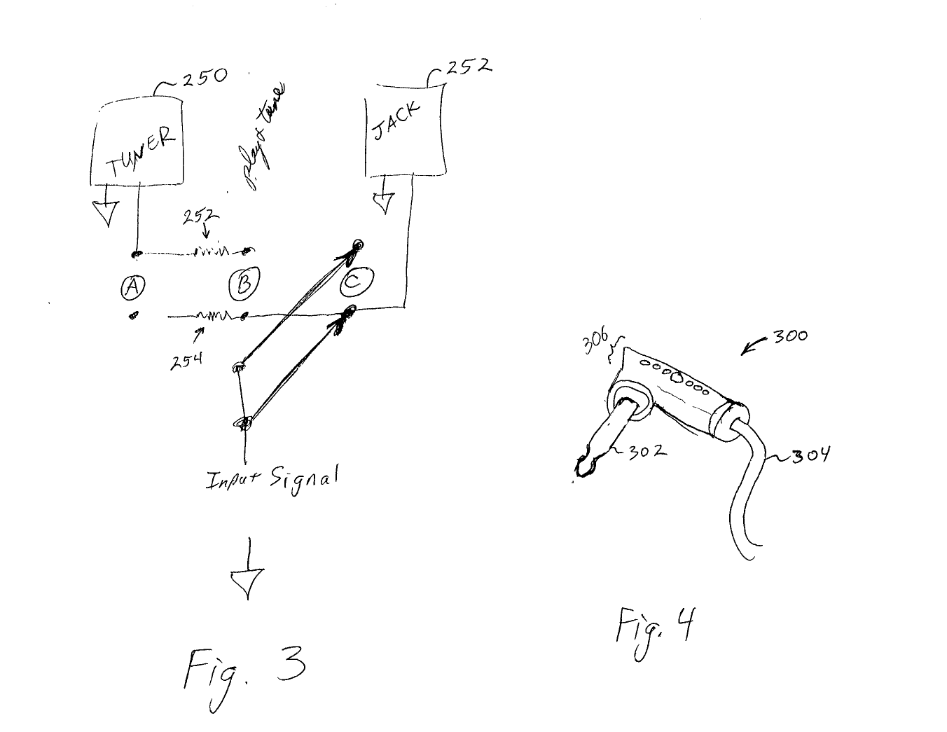

Returning to the preferred embodiment, FIG. 3 illustrates the electronic operation of selector switch 202 shown in FIG. 2c.

In FIG. 3, a slider switch is used that has 3 positions A, B and C. Each position provides a different function for applying the instrument signal received at plug 214 to either tuner electronics 250, jack 252, or both. In position A, the input signal is coupled only to tuner electronics 250 and no signal is conveyed to jack 252. Jack 252 corresponds to jack 204 of FIG. 2C. Thus, the instrument can be tuned without the signal being sent to an external device, such as an amplifier. This is useful to spare an audience from the somewhat unpleasant sounds of an instrument being tuned.

Position B provides the instrument signal to both tuner electronics 250 and jack 252. Thus, the tuner can be used simultaneously with the signal being sent to an external device. This is useful where a musician would like to tune the instrument while hearing the sound amplified so that the sound is audible to the musician or others. Note that in position B, resistor 254 is used to provide a high impedance path to tuner 250. This is useful so that most of the input signal energy goes to jack 252 and to any external device. This provides a stronger, cleaner signal to the external device.

Also note that in moving from position A to B, the signal is applied to jack 252 through resistor 254. This prevents loud and damaging sounds and signals from being generated in, or by, the external devices. Once the slider switch has been moved to position B, resistor 254 is no longer used so that the signal to jack 252 is not diminished other than by the parallel path through resistor 252 to tuner electronics 250.

Finally, in position C, the signal is sent only to jack 252 for use by external devices. Note that in position C the switch should also cut the power to tuner electronics 250 so that battery life can be extended and unwanted tuner operation or indicator lighting can be avoided. Other selector switch configurations can be employed. The preferred embodiment only has a simple on/off switch which either turns the tuner power on or off. In the preferred embodiment, the input signal is always coupled both to the tuner electronics and the jack.

In other embodiments the tuner need not be immediately adjacent to the instrument. For example, there can be a cable run of a few inches so that the tuner is suspended from the cable plugged into the instrument jack. This has a disadvantage that the tuner display will not be fixed in an easily viewable position. The musician must reach down and grab the device to operate or view it. However, an advantage is that different tuner models do not have to be manufactured for different instruments with different jack and surface arrangements. The tuner can be affixed to the instrument by other means than the jack/plug tension—such as by affixing to the strap on the guitar.

Thus, the invention has been discussed with respect to various embodiments thereof. However, many variations on the embodiments are possible which remain within the scope of the invention. The disclosure is to be regarded as illustrative, not restrictive of the invention, the scope of which is determined by the appended claims.

What is claimed is:

1. A musical tuning device integral with a plug for coupling the device adjacent to a musical instrument to be tuned.

2. The musical tuning device of claim 1, wherein the plug is a one-quarter inch plug.

3. The musical tuning device of claim 1, further comprising
a connector coupled to the device for outputing a sound signal from the musical instrument; and
a switch mounted on the device for inhibiting the outputing of the sound signal while tuning.

4. The musical tuning device of claim 1, further comprising
a plurality of light emitting indicators for indicating whether a sound output from the musical instrument is in tune.

5. The musical tuning device of claim 1, wherein the musical instrument is an electric guitar worn by a human musician to facilitate playing of the electric guitar, the device further comprising
an indicator for indicating an in-tune or out-of-tune condition of a signal output by the electric guitar, the indicator oriented to be visible by the musician.

6. The musical tuning device of claim 5, wherein the indicator comprises
a display surface;
two or more indicators coupled to the display surface;
a mounting of the display surface at an angle such that the display surface is not parallel with the top face of the guitar.

7. The musical tuning device of claim 6, wherein the angle is greater than 90 degrees.

8. An electric guitar tuning device, wherein the electric guitar includes a jack for accepting an electrical input signal, the tuning device comprising a plug for coupling the electrical input signal to the electric guitar;
a physical coupling for securing the tuning device to the plug; and
an electrical coupling for coupling the tuning device to the electrical input signal.

9. The tuning device of claim 8, wherein the physical coupling integrates the plug and tuning device.

10. The tuning device of claim 8, wherein the physical coupling includes a cable coupled to both the plug and tuning device.

11. The tuning device of claim 8, further comprising
wherein the physical coupling includes a movable coupling allowing the tuning device to be manually positioned once the plug is inserted into the jack.

12. The tuning device of claim 11, wherein the movable coupling further comprises
a length of cable between the plug and tuning device.

13. The tuning device of claim 8, further comprising
an input jack to the tuning device.

14. The tuning device of claim 8, further comprising
an input cable coupled to the tuning device for receiving the electrical input signal.
